(19) United States
(12) Patent Application Publication
(10) Pub. No.: US 2009/0108238 A1
(43) Pub. Date: Apr. 30, 2009

(54) CATALYST FOR REFORMING HYDROCARBONS

(75) Inventors: Jon P. Wagner, Louisville, KY (US); Chandra Ratnasamy, Louisville, KY (US); Charles D. Faulk, Sellersburg, IN (US)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE INC., Louisville, KY (US)

(21) Appl. No.: 11/931,391

(22) Filed: Oct. 31, 2007

(51) Int. Cl. C01B 3/38; B01J 21/08; B01J 23/10; B01J 23/24; B01J 23/28; B01J 23/30; B01J 23/00; B01J 23/34; B01J 23/40; B01J 23/42; B01J 23/44; B01J 21/04

(52) U.S. Cl. 252/373; 502/325; 502/339; 502/300; 502/340; 502/324; 502/302; 502/349; 502/255; 502/313; 502/303; 502/304; 502/241; 502/262; 502/261

(57) ABSTRACT

A catalyst for reforming hydrocarbons comprising a precious metal, preferably selected from the group consisting of rhodium, platinum, palladium, osmium, iridium, ruthenium, rhenium, and combinations thereof deposited on a support, wherein the support is produced from a mixture of a low surface area material and a high surface area material.

### BACKGROUND OF INVENTION

An embodiment of the present invention relates to catalysts for catalytic reforming of hydrocarbons utilizing a precious metal deposited upon a support, wherein the support is formed from a mixture of a low surface area material and a high surface area material. An embodiment of the present invention also relates to processes for the preparation of the reforming catalyst and processes for use of the reforming catalysts for reforming hydrocarbons.

Various processes have been utilized for the production of hydrogen from hydrocarbons. Generally, hydrocarbons react at high temperatures in the presence of water vapor on a suitable catalyst to produce hydrogen, carbon monoxide, and carbon dioxide. The process is generally referred to as steam reforming. The reaction is highly endothermic and proceeds based on the following reaction process:

Cₙ Hₘ+H₂O⇄CO₂+H₂

Another process utilized for the production of hydrogen is referred to as partial oxidation, whereby a hydrocarbon is converted to carbon dioxide and hydrogen in the presence of oxygen utilizing a catalyst. This reaction is highly exothermic and proceeds based on the following reaction process:

Cₙ Hₘ+O₂⇄CO₂+H₂

A third process for the production of hydrogen combines these two reaction processes and is called autothermal reforming. In this process the exothermic partial oxidation reaction frequently supplies the heat of reaction required for the endothermic steam reforming reaction. The reaction proceeds based on the following reaction formula:

Cₐ H_{b}+xO₂+yH₂O⇄aCO₂+(b/2+2a-2x)H₂+(y+2x-2a)H₂O

Ideally, the autothermal reaction converts all fuel to CO₂ and H₂. Preferably, the reaction is conducted near thermal neutral conditions. The autothermal reaction has shown particular utility as a process for use with fuel cells as autothermal reforming can be an effective method for generating hydrogen from hydrocarbon fuels while producing conventional reaction by products.

For hydrogen generation, particularly for use in a conventional low temperature fuel cell processing train, such as a proton exchange membrane (PEM) fuel cell, which is suitable for use in a stationary application or in a vehicle, such as an automobile, the hydrocarbon fuel stream can be derived from a number of conventional fuel sources, with the preferred fuel sources including natural gas, propane and LPG. In a conventional hydrogen generation system, particularly a fuel cell processing train, the hydrocarbon fuel stream is passed over and/or through a desulfurization system to be desulfurized. The desulfurized hydrocarbon fuel stream then flows into a reformer, wherein the fuel stream is converted into a hydrogen-rich fuel stream. The reformer may utilize any conventional reforming reaction such as steam reforming, partial oxidation or autothermal reforming. From the reformer the fuel stream passes through one or more heat exchangers to a shift converter where the amount of CO in the fuel stream is reduced. From the shift converter the fuel stream again passes through various heat exchangers and then through a selective oxidizer or selective methanizer having one or more catalyst beds, after which the hydrogen rich fuel stream flows to the fuel cell stack where it is utilized to generate electricity.

While a number of reforming catalysts are known, improved reforming catalysts are needed which exhibit a high percentage of conversion of the feed stream into hydrogen, while retaining stability at high temperatures.

One object of a preferred embodiment of the invention is to produce reforming catalysts which exhibit high conversion capacity while retaining significant surface area stability, even at high temperatures.

Another object of a preferred embodiment of the invention is a process for the production of the reforming catalysts.

Another object of a preferred embodiment of the invention is a use of these catalysts for reforming conventional feed streams.

These and other objects are obtained by the catalysts of preferred embodiments of the invention, their processes of manufacture and of use.

### BRIEF DESCRIPTION OF THE FIGURES

FIG. 1 is a graph illustrating the CH₄ conversion percentage over time for three catalysts operating at the stated conditions. The composition of the catalysts is described in the Examples.

FIG. 2 is a graph illustrating the retention of surface area at high calcination temperatures for the three catalysts of FIG. 1.

### SUMMARY OF INVENTION

One of the preferred embodiments of the invention disclosed herewith is a catalyst for reforming hydrocarbons comprising one or more precious metals, selected from the group consisting of rhodium, platinum, palladium, osmium, iridium, ruthenium, rhenium, and combinations thereof, with the combination of rhodium and platinum preferred, deposited on a support, wherein the support is formed from a mixture comprising from about 10 to about 60 percent by weight of a low surface area material, wherein the surface area of the low surface area material is less then about 20 m²/g, preferably from about 1 m²/g to about 10 m²/g, and from about 40 to about 90 percent of a high surface area material, wherein the surface area of the high surface area material is from about 80 m²/g to about 300 m²/g, preferably from about 80 m²/g to about 200 m²/g. The catalyst composition may be formed as a tablet, extrudate or powder or washcoated on a cordierite or metal monolith or on a metal or ceramic foam or similar washcoat surface.

Another embodiment is various processes for reforming a hydrocarbon feed stream utilizing the catalysts described above utilizing steam reforming, partial oxidation or autothermal reforming processes.

A further embodiment is a process of forming the catalysts described above.

### DETAILED DESCRIPTION OF THE INVENTION

One embodiment of the present invention is a catalyst tablet or extrudate or catalytic washcoat for reforming hydrocarbons comprising one or more precious metals, selected from the group consisting of rhodium, platinum, palladium, osmium, iridium, ruthenium, rhenium, and combinations thereof, deposited upon a support, wherein the support is formed from a mixture comprising from about 10 to about 60 percent by weight of a low surface area material, wherein the surface area of the low surface area material is less than about 20 m²/g, and from about 40 to about 90 percent of a high surface area material, wherein the surface area of the high surface area material is from about 80 to about 300 m²/g.

The catalyst or catalytic washcoat can be utilized for a number of reforming reactions including steam reforming, catalytic partial oxidation and autothermal reforming reactions.

The catalyst or catalytic washcoat for reforming hydrocarbons comprises one or more precious metals deposited upon a support. The one or more precious metals that are deposited upon the support are selected from the group consisting of rhodium, platinum, palladium, osmium, iridium, ruthenium, rhenium and combinations thereof. In one preferred embodiment the precious metal utilized comprises rhodium utilized alone. In another preferable embodiment rhodium and platinum are utilized together. The total quantity of the precious metal(s) that is deposited upon the support for the reforming catalyst or catalytic washcoat of one embodiment of the invention is from about 0.05 to about 5 percent by weight, preferably from about 0.1 to about 3 percent by weight. In one preferred embodiment the catalyst comprises from about 0.1 to about 5 percent of rhodium. In another preferred embodiment the precious metal comprises a combination of from about 0.1 percent to about 2 percent of rhodium and from about 0.05 to about 3 percent of platinum. The inventors have surprisingly discovered that a reforming catalyst with improved performance characteristics, especially high temperature stability, can be produced when the support for the precious metal is formed from a mixture comprising a low surface area material and a high surface area material. While a person skilled in the art would have anticipated that the mixture of a high surface area material and a low surface material would yield a material with a surface area in between the surface areas of the two materials, it has surprisingly been discovered that the combination yields a material with a higher than expected surface area retention at high temperatures with greater stability for the desired reactions.

For purposes of this disclosure, “low surface area” means less than 20 m²/g and preferably from 1 m²/g to 10 m²/g. One embodiment of the low surface area material of the invention includes a calcium compound combined with an aluminum compound or a MeO/alumina compound, wherein Me is selected from Ca, Sr, Ba, Mg, Mn, Ni and combinations thereof. Preferred low surface area materials include various aluminates, more preferably calcium aluminate, various hexaaluminates, more preferably selected from barium hexaaluminate, strontium hexaaluminate, manganese hexaaluminate, magnesium hexaaluminate, and combinations thereof. In a more preferred embodiment the low surface area material is a mixture of calcium aluminate and a hexaaluminate, most preferably barium hexaaluminate. In a most preferred embodiment the low surface area material mixture comprises substantially all a hexaaluminate or mixture of hexaaluminates.

When calcium aluminate is utilized, the preferred calcium compound is combined with the preferred aluminum compound to form various calcium aluminates, such as CaO.6Al₂O₃, CaO.2Al₂O₃ and CaO.Al₂O₃. However, any stable calcium aluminate can be utilized.

The preferred low surface area material can be produced by conventional procedures, such as by physically mixing the calcium compound or the MeO with the alumina compound and then calcining the resultant mixture, or by purchasing the low surface area material, for example, by purchasing a Süd-Chemie G90 support material.

For purposes of this disclosure, a “high surface area” material has a surface area from about 80 to 300 m²/g, preferably from about 80 to 200 m²/g. One preferred embodiment of the high surface material comprises a high surface area alumina onto which has been impregnated various dopants, including one or more selected from the group consisting of yttria, ceria, zirconia and oxides of the lanthanides. The preferred alumina is a transitional alumina, preferably gamma alumina, with a surface area greater than 200 m²/g, preferably up to 250 m²/g or so. A particularly preferred embodiment of the high surface area material comprises a gamma alumina onto which has been impregnated ceria, yttria, and lanthana. A most preferred high surface area material comprises 1-5% yttria, 1-5% lanthana, 14-20% ceria with the remaining amount comprising gamma alumina, with all amounts determined by weight. Additional dopants can be added to this high surface area ceria, yttria and lanthana on alumina material including zirconia. Other dopants which may also be added include Sn, Mn, Pr, Nd, Nb, Sm, W, their oxides and mixtures thereof.

Another preferred high surface area material is a mixed metal oxide material with oxides selected from two or more of the following: zirconia, ceria, titania, silica, lanthana, praseodymia, neodymia, yttria, samaria, tungsten oxide, molybdenum oxide, calcium oxide, chromium oxide, manganese oxide and magnesium oxide. One particularly preferred high surface area mixed metal oxide combination comprises zirconia and ceria, with the preferred ratio of zirconia to ceria being about 1 to about 10 to about 10 to about 1. In a particularly preferred embodiment, praseodymia and/or neodymia are added to the ceria/zirconia support. The praseodymia and/or neodymia preferably comprise from about 3% to about 30% of the support, by weight. When both are present in the support, the ratio of the praseodymia to the neodymia is preferably from 1 to 1 to about 3 to 1.

The mixed metal oxide support high surface area material can be produced by blending together the metal oxides using conventional procedure or the mixed metal oxide can be purchased from conventional sources separately or after combination thereof.

Alternatively, the high surface area material may preferably comprise high surface area ceria, titania, or silica and mixtures thereof.

Following the production or acquisition of the low surface area material and the high surface area material, they are combined to produce the carrier for the reformer catalyst of one embodiment of the invention. Various conventional production procedures may be used for this combination. In a preferred embodiment the high surface area material and the low surface area material are physically mixed, calcined and then washcoated onto a surface by conventional washcoat procedures or extruded to form extrudates. Alternatively, the composition, after mixing and calcining, can be formed into powders or tablets.

Once the high surface area and low surface area materials are formed into the support, the precious metal material is impregnated onto that support. In one preferred procedure, the precious metal is incorporated into the support material, preferably by impregnation, in the form of a precious metal salt solution. For example, when the precious metal is rhodium, the support material may be immersed in a rhodium salt solution, such as rhodium nitrate, and then dried and calcined at a temperature from about 350° to about 650° C. for about 1 to about 5 hours to transform the rhodium salt to rhodium oxide. Depending on the target loading, multiple impregnation steps may be needed.

After formation of the final product, the surface area of the catalyst is preferably from about 100 m²/g to 200 m²/g, more preferably from about 100 m²/g to about 170 m²/g, and most preferably from about 150 m²/g to about 160 m²/g.

The catalysts of the preferred embodiments are especially useful for reforming reactions, including steam reforming, partial oxidation and autothermal reforming, where the feed stream contains hydrocarbons, such as CH₄. A quantity of steam may be added to the feed stream along with a source for oxygen. Generally the reforming conditions include a molar steam/carbon ratio of about 0.1 to 10, preferably about 0.5 to 5 at a temperature from about 350° C. to 900° C., preferably about 450° C. to 800° C. In one embodiment the feed stream passes over or through a bed containing the invention catalyst in the form of extrudates, tablets or powders. Alternatively, the feed stream may pass over a support onto which the catalytic material of the invention has been deposited. By use of this catalyst, substantially higher quantities of hydrogen are produced than can be produced using conventional reforming catalysts. In addition, the catalysts have shown greater stability than prior art catalysts, especially at high temperatures.

### EXAMPLES

The catalyst of a preferred embodiment of the invention (Catalyst A) is compared by performance with a catalyst containing the same precious metal loading but deposited solely on a high surface area material (Catalyst B) and also a catalyst with the same precious metal loading deposited on a low surface area material (Catalyst C).

Catalyst A is produced by depositing 0.8 percent rhodium on a carrier produced from a mixture of a low surface area material and a high surface area material. The low surface area material comprises calcium hexaaluminate, wherein 13% comprises calcium with the remaining amount being alumina, and the high surface area material comprises 1.5% by weight yttria, 3% by weight lanthana, 16% by weight ceria and the rest gamma alumina. The ratio of the low surface area material to the high surface area material by weight is 30:70. The surface area of this support material after production is 160 m²/g.

Catalyst B is produced by depositing 0.8% rhodium on the high surface area material utilized with catalyst A.

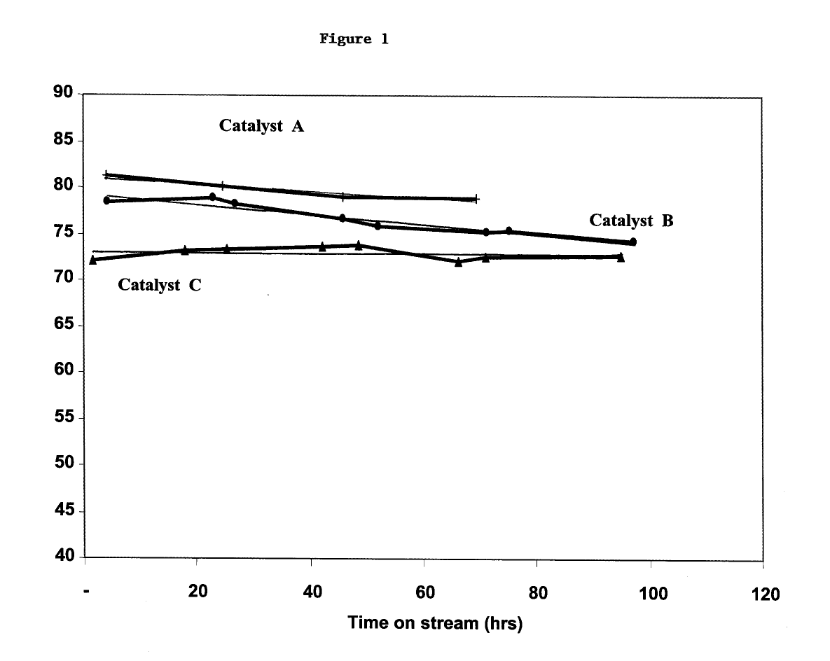

Catalyst C is produced by depositing 0.8% rhodium on a low surface area material comprising calcium hexaaluminate with calcium aluminate of Catalyst A. The results are shown in FIG. 1.

The test run is described as follows: The catalyst to be tested in the form of a monolith extrusion is loaded into a test bed and tested at 700° C. for autothermal reforming. The volume of catalysts used is 1.285 cc with a total flow of gas of 642.7 liters per hour. The steam to carbon ratio is 25 and the oxygen to carbon ratio is 0.7.

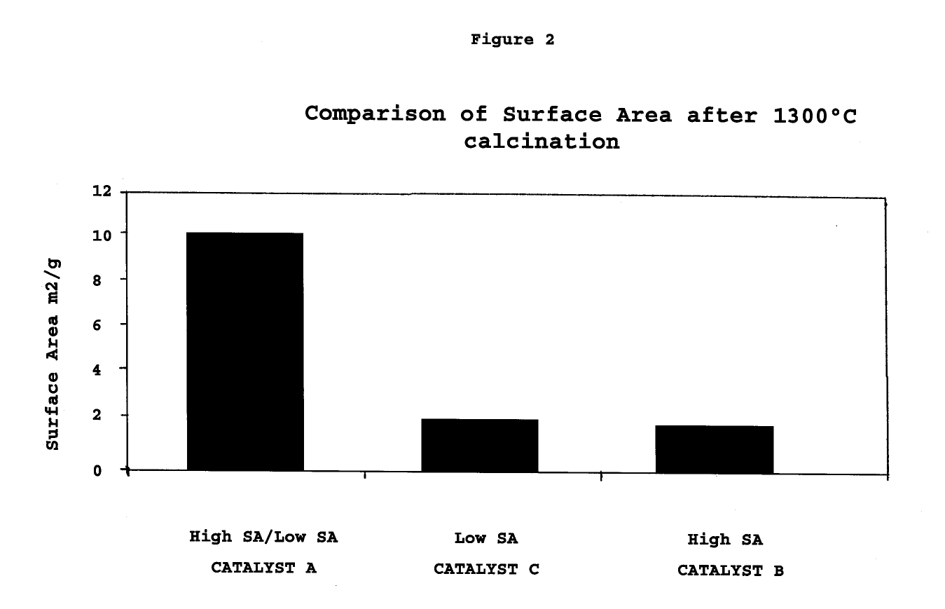

In addition, the surface area stability of each of the catalysts described above is tested by increasing the calcination temperature of the catalyst to 1300° C. in air. The retention of the surface area of the catalysts is compared and shown in FIG. 2.

From an analysis of these tests, it is clear that the CH₄ conversion by the catalyst with a support produced from a mixture of both a high surface area and a low surface area material was greater than catalysts produced wherein only a low surface area material was used to form the support or wherein only a high surface area material was used to form the support. Further, the stability of the catalyst utilizing a support produced from a mixture of both a high surface area and low surface area material had a higher surface area at higher calcination temperatures than that of the other two catalysts.

Although one or more embodiments of the invention have been described in detail, it is clearly understood that the descriptions are no way to be taken as limitations. The scope of the invention can only be limited by the appended claims.

1. A catalyst for reforming hydrocarbons comprising
a precious metal, selected from the group consisting of rhodium, platinum, rhenium, palladium, osmium, iridium, ruthenium and combinations thereof, deposited on a support;
wherein the support is formed from a mixture comprising from about 10 to about 60 percent by weight of a low surface area material, wherein the surface area of the low surface area material is less than 20 m²/g, and from about 40 to about 90 percent by weight of a high surface area material, wherein the surface area of the high surface area material is from about 80 to about 300 m²/g.

2. The catalyst of claim 1 wherein the low surface area material is selected from the group consisting of calcium aluminate, barium hexaaluminate, magnesium hexaaluminate, strontium hexaaluminate, manganese hexaaluminate and mixtures thereof.

3. The catalyst of claim 1, wherein the low surface area material comprises an aluminum compound comprising MeO/alumina, wherein Me is selected from Ca, Sr, Ba, Mg, Mn, and combinations thereof.

4. The catalyst of claim 3 wherein Me comprises Ba.

5. The catalyst of claim 1, wherein the low surface area material comprises calcium aluminate.

6. The catalyst of claim 1, wherein the surface area of the low surface area material is from about 1 to about 10 m²/g.

7. The catalyst of claim 1, wherein the high surface area material comprises alumina promoted with oxides selected from the lanthanides, yttria, ceria, zirconia and mixtures thereof.

8. The catalyst of claim 1, wherein the high surface area material comprises a gamma alumina combined with about 1-5% yttria, about 15-20% ceria and about 1-5% lanthana, by weight.

9. The catalyst of claim 1, wherein the high surface area material comprises a mixed metal oxide, which oxides are selected from two or more of the following: zirconia, ceria, titania, silica, lanthana, praseodymia, neodymia, yttria, samaria, tungsten oxide, molybdenum oxide, calcium oxide, chromium oxide, manganese oxide and magnesium oxide.

10. The catalyst of claim 1, wherein the high surface area material comprises a material selected from high surface area ceria, titania, silica and mixtures thereof.

11. The catalyst of claim 1, wherein the high surface area material comprises a mixture of ceria, zirconia and one or more lanthanide oxides.

12. The catalyst of claim 11, wherein the lanthanide oxides comprise praseodymium oxide and/or neodymium oxide.

13. The catalyst of claim 1, wherein the surface area of the high surface material comprises 80 to about 200 m²/g.

14. The catalyst of claim 1, wherein the precious metal comprises 0.1 to about 5 percent, by weight of the catalyst.

15. The catalyst of claim 1, wherein the precious metal consists of rhodium.

16. The catalyst of claim 1, wherein the precious metal consists of a mixture of rhodium and platinum.

17. A catalyst for reforming hydrocarbons comprising a precious metal, selected from the group consisting of rhodium and platinum and mixtures thereof, deposited on a support, wherein the support is formed from a mixture comprising from about 10 to about 60 percent by weight of a low surface area material, wherein the surface area of the low surface area material is from about 1 to about 10 m²/g, and wherein the low surface area material is selected from the group consisting of calcium aluminate, barium hexaaluminate, magnesium hexaaluminate, strontium hexaaluminate, manganese hexaaluminate and mixtures thereof, and wherein the mixture further comprises from about 40 to about 90 percent of a high surface area material, wherein the surface area of the high surface area material is from about 80 to about 200 m²/g and wherein the high surface area material comprises gamma alumina combined with ceria, yttria, and lanthana.

18. The catalyst of claim 17, wherein the high surface area material comprises gamma alumina combined with about 1-5% yttria, about 15-20% ceria and about 1-5% lanthana, by weight.

19. A catalyst for reforming hydrocarbons comprising a precious metal selected from the group consisting of rhodium and platinum and mixtures thereof, deposited on a support, wherein the support is formed from a mixture comprising from about 10 to about 60 percent by weight of a low surface area material, wherein the surface area of the low surface area material is from about 1 to about 10 m²/g, and wherein the low surface area material is selected from the group consisting of calcium aluminate, barium hexaaluminate, magnesium hexaaluminate, strontium hexaaluminate, manganese hexaaluminate and mixtures thereof, and wherein the mixture further comprises from about 40 to about 90 percent of a high surface area material, wherein the surface area of the high surface area material is from about 80 to about 200 m²/g and wherein the high surface area material comprises ceria, zirconia and one or more lanthanide oxides.

20. A steam reforming reaction comprising reacting hydrocarbons in the presence of water vapor at high temperatures over a catalyst to produce hydrogen and carbon oxides, wherein the catalyst comprises
a precious metal, selected from the group consisting of rhodium, platinum, rhenium, palladium, osmium, iridium, ruthenium and combinations thereof, deposited on a support;
wherein the support is formed from a mixture comprising from about 10 to about 60 percent by weight of a low surface area material, wherein the surface area of the low surface area material is less than 20 m²/g, and from about 40 to about 90 percent by weight of a high surface area material, wherein the surface area of the high surface area material is from about 80 to about 300 m²/g.

21. A partial oxidation reaction comprising reacting hydrocarbons in the presence of oxygen over a catalyst to produce carbon oxides and water, wherein the catalyst comprises
a precious metal, selected from the group consisting of rhodium, platinum, rhenium, palladium, osmium, iridium, ruthenium and combinations thereof, deposited on a support;
wherein the support is formed from a mixture comprising from about 10 to about 60 percent by weight of a low surface area material, wherein the surface area of the low surface area material is less than 20 m²/g, and from about 40 to about 90 percent by weight of a high surface area material, wherein the surface area of the high surface area material is from about 80 to about 300 m²/g.

22. An autothermal reforming reaction comprising reacting hydrocarbons in the presence of water vapor and oxygen over a catalyst to produce hydrogen and carbon oxides, wherein the catalyst comprises
a precious metal, selected from the group consisting of rhodium, platinum, rhenium, palladium, osmium, iridium, ruthenium and combinations thereof, deposited on a support;
wherein the support is formed from a mixture comprising from about 10 to about 60 percent by weight of a low surface area material, wherein the surface area of the low surface area material is less than 20 m²/g, and from about 40 to about 90 percent by weight of a high surface area material, wherein the surface area of the high surface area material is from about 80 to about 300 m²/g.
